(19) United States
(12) Patent Application Publication
(10) Pub. No.: US 2021/0155521 A1
(43) Pub. Date: May 27, 2021

(54) PREPARATION OF RAW MATERIALS FOR GLASS FURNACE

(71) Applicant: SAINT-GOBAIN GLASS FRANCE, COURBEVOIE (FR)

(72) Inventors: Bertrand BARET, MONTMAGNY (FR); Alexandre MARTIN, MONTLIGNON (FR); William WOELFFEL, PARIS (FR); Sophie PAPIN, FLEURINES (FR)

(21) Appl. No.: 17/257,193

(22) PCT Filed: Jun. 27, 2019
(86) PCT No.: PCT/FR2019/051591

§ 371 Date: Dec. 30, 2020

(30) Foreign Application Priority Data
Jul. 3, 2018 (FR) 1856124

(51) Int. Cl. C03B 3/02; C03B 5/235

(52) U.S. Cl. CPC C03B 3/023; C03B 5/2356

(57) ABSTRACT

A device and to a process for the preparation and charging of starting materials for a glass furnace includes a system for carrying out a mixing of starting material powder and of liquid water producing a moistened mass of starting material powder, to a system for carrying out a mixing of cullet with the moistened mass of starting material powder producing a mixture of starting material and of cullet, known as SM/C mixture, a starting material preheater in which the SM/C mixture circulates and is heated and dried in order to produce a mass to be charged, then a system for charging the glass furnace with the mass to be charged.

The invention relates to a device and to a process for preparing and charging starting materials to a glass furnace.

The laboratory volume of flame glass furnaces is swept with strong gas streams capable of entraining, with them, a portion of the pulverulent starting material introduced into the furnace. Some powders, such as sand, limestone or dolomite, have a tendency to be particularly volatile. In particular, dolomite fragments under the effect of the temperature (“crackling” phenomenon), occasioning more fly-offs. These fly-offs of starting material produce the following disadvantages:
the material flown off is deposited in the ducts for conveying the flue gases, such as in the burner chambers, the regenerators or recuperators, producing fouling, indeed even obstruction, of these ducts and requiring that they be dismantled and then cleaned, and even being able to limit the lifetime of the furnace,
the composition desired can, as the case may be, be modified if these fly-offs impact some materials more than others,
they represent a loss of starting material.

Moistening the pulverulent starting material is a means of reducing fly-offs during the transportation by conveying before the furnace and then in the furnace. However, this moistening represents a loss of heating energy of the furnace. The moistening followed by the drying of the starting material before charging is also a solution for producing agglomerates less subject to fly-offs, in particular by adding binders and/or by using specific materials which promote the formation of these agglomerates. However, while briquettes are not intentionally formed by a shaping system and while the conventional way of carrying out the mixing of powders is used, the drying of a premoistened composition can result in the formation of large blocks of starting material which flow very poorly, indeed even which result in the blocking of the starting material preheaters (batch preheaters), in particular those in which the material flows at least partially in the vertical position. This can lead to the progression of the starting material for the purpose of the charging thereof being halted and require a manual intervention of operators in order to restart the plant.

U.S. Pat. No. 5,100,840 teaches the formation of briquettes of starting material to be charged. Mention may be made, as other documents of the state of the art, of DE102012224139, DE19836869 and U.S. Pat. No. 4,248,616.

It has now been found that the fly-offs can be limited and the kinetics of melting accelerated if a certain state of structuring of the vitrifiable mixture is maintained. This state is brought about by the addition of water and is maintained after drying if the mixture is not stirred excessively roughly subsequent to this drying. It can be obtained by a ready modification of a plant for the preparation of vitrifiable mixture. This state of structuring, according to which the vitrifiable mixture comprises agglomerates, has to be controlled in order not to bring about blocking on conclusion of the drying, and the presence of cullet has appeared beneficial with regard to this point. It appears that the incorporation of cullet promotes the fragmentation of the largest agglomerates of starting material or prevents the formation of excessively large aggregates, which is favorable to its progression during its conveying, in particular in the preheaters in which material circulates at least partially vertically, indeed even continuously vertically. Preheaters in which the material flows vertically, which are highly suitable for the present invention, are described in DE102012204439, EP 2 138 465 and EP 2 248 773. The fact that the surface of the cullet pieces is smooth might favor this fragmentation due to the low adherence of the starting material to them. The size of the cullet pieces would also be important for shearing the moving material. The mass of vitrifiable materials to be charged thus prepared remains less subject to fly-offs as the smallest aggregates are not fragmented. Moreover, the existence of aggregates also makes it possible to accelerate the rate of melting of the mixture in order to form the glass.

The invention relates to a device for the preparation and charging of starting materials for a glass furnace, comprising:
a means for carrying out a mixing of starting material powder and of liquid water, producing a moistened mass of starting material powder, said means comprising a tank provided with a stirring means, with an inlet for the starting material powder, with a feed of liquid water and/or of steam and with an outlet for the moistened mass of starting material powder,
a system for carrying out a mixing of cullet with the moistened mass of starting material powder which has exited from the tank, in order to produce a mixture of starting material and of cullet, known as SM/C mixture,
a starting material preheater in which the SM/C mixture circulates and is heated and dried in order to produce a mass to be charged, then
a system for charging the glass furnace with the mass to be charged.

The invention makes it possible to be freed from the use of a system for shaping the starting material using molds, resulting in graded agglomerates (briquettes, balls, granules, pellets and the like), such as binding compactors. Neither does the invention require the use of a technique for granulation of the starting material according to which the material is rotated (in particular in a tank of rotating drum type), generally in the presence of a binder, so as to result in granules (pellets). The SM/C mixture entering the preheater is thus not shaped and neither does the preheater deliver a shaped mass. The preheater delivers a mass to be charged comprising agglomerates of random shape.

In the preheater, the SM/C mixture flows at least partially vertically, that is to say by a movement comprising a vertical component, indeed even exclusively vertically. This flow takes place under the effect of gravity. The mass to be charged exits from the preheater at a lower height than that at which the SM/C mixture entered the preheater. The outlet of the preheater is even generally found in the vertical position below its inlet. The SM/C mixture is heated and dried in the preheater. The device according to the invention can comprise a pipe conveying combustion flue gases generated by the glass furnace to the preheater, so as to provide the latter with the thermal energy for heating and drying the SM/C mixture. The flue gases circulate in the preheater via at least one pipe. The flue gases can come into direct contact with the SM/C mixture. In order to reduce the risks of fly-off, the combustion flue gases may only partially or not at all come into contact with the SM/C mixture in the preheater. The SM/C mixture and the combustion flue gases may circulate in separate pipes in the preheater, generally countercurrentwise. These pipes can be separated while being able to comprise communication orifices which make it possible for gases to escape from the SM/C mixture in order to mix with the combustion flue gases. This is because a pipe in which the SM/C mixture circulates can comprise orifices which communicate with a pipe in which the combustion flue gases circulate in order to facilitate the evacuation of the gases escaping from the SM/C mixture toward a pipe in which the combustion flue gases circulate. This is because the SM/C mixture releases steam as it progresses through the preheater. These gases released by the SM/C mixture will then, at least in part, join the combustion gases. The preheater delivers a mass of vitrifiable materials to be charged. Following the preheater, this mass to be charged is conveyed to the furnace, by a system which can, for example, comprise a forwardly progressing belt, and then it is introduced into the furnace by a screw charger or any other appliance well known to a person skilled in the art. The preheater can, for example, be of the type of one of those described in U.S. Pat. No. 5,526,580, CN201458942 or DE3716687.

The invention also relates to a glass furnace equipped with the device according to the invention. The invention also relates to a process for the melting of glass in a furnace, in particular a furnace provided with the device for the preparation and charging of starting material according to the invention, comprising:
the carrying out, in a tank, of a mixing of starting material powder and of liquid water, producing a moistened mass of starting material powder, said tank being provided with a stirring means, with an inlet for the starting material powder, with a feed of liquid water and/or of steam and with an outlet for the moistened mass of starting material powder, then
the mixing of cullet with the moistened mass of starting material powder which has exited from the tank, in order to produce a mixture of starting material and of cullet, known as SM/C mixture, then
the heating and drying of said SM/C mixture in a preheater, producing a mass to be charged, then
the charging to the furnace of said mass to be charged.

In the context of the present invention, the water complexed in a compound, such as a hydrate, is distinguished from the noncomplexed water, which is said to be “free”. The expression “liquid water” is used to denote condensed free water, which includes the water adsorbed at the surface of grains. Steam is gaseous, thus noncondensed, free water. It is also possible to speak of the total mass of water present in the moistened mass of starting material powder or in the SM/C mixture or in the mass to be charged and it then concerns the sum of the mass of free (that is to say liquid) water and of complexed water present in these compositions.

According to the invention, a mixture of liquid water and of starting material powder is produced. This starting material powder can contribute water by itself, either in the form of liquid water (in particular by the sand) or in the form of a hydrate of a compound in which the water is complexed (example: a sodium carbonate hydrate). Generally, if the starting material powder contributes water, more than 95% of the mass of this water is liquid (that is to say free) water. Generally, the starting material powder does not contain hydrate at the start. If the starting material powder contributes liquid water, this is taken into account in order to quantify the amount of liquid water which is added to it in order to produce the mixture of starting material powder and of liquid water. Liquid water is added to the starting material powder so that the sum of the mass of the liquid water contributed at the start by the starting material powder and of the liquid water added to the starting material powder represents at least 0.5% and generally at least 1% of the moistened mass of starting material powder and at most 10% and generally at most 3.5% of the moistened mass of starting material powder.

The mixture of liquid water and of starting material powder is produced in a tank and with stirring. In the tank, during the kneading, the content of liquid water (thus also of free water) can decrease if a hydrate is formed, the water then passing from the free state to the complexed state. Cullet is not generally added during the preparation of this mixture. This mixture thus generally does not comprise cullet (or else less than 5% by mass of cullet on a dry basis) when it leaves the tank. The presence of cullet in a tank provided with stirring would have harmful consequences on the wear of the tank and would require more energy in order to carry out the stirring.

The mixing of starting material powder and of liquid water is carried out in a tank equipped with a stirring means. It can, for example, be a THZ kneader sold by Teka. In this tank, it is possible to directly introduce liquid water and, if appropriate, also water in the form of steam (which is also free but gaseous water), which rapidly condenses in the tank to give liquid water in the free space between the injection of steam and the surface of the starting materials, and also on the starting material grains. To introduce steam into a tank is thus also a means of contributing liquid water in order to produce the mixture of starting material powder and of liquid water. Furthermore, as the steam has a temperature generally of at least 100° C., it also contributes to heating the starting material powder.

Preferably, before carrying out the mixing of starting material powder and of liquid water, the starting material powder comprises a compound capable of dissolving at least partially in the liquid water of the moistened mass of starting material powder and of then precipitating in the hydrate form (comprising more complexed water than before its dissolution), behavior known as “dissolution/precipitation”. This compound consumes free water in order to render it complexed. By way of example, nonhydrated sodium carbonate has such a behavior. The nonhydrated sodium carbonate (which thus does not contain any complexed water) at least partially dissolves in the liquid water and then precipitates in the form of sodium carbonate monohydrate (which thus contains one mole of complexed water per mole of sodium carbonate). This monohydrate is more stable above 36° C. This “dissolution/precipitation” phenomenon promotes the formation of bridges between the starting material powder grains, which contributes to giving the starting material cohesion and a tendency to form agglomerates. This compound exhibiting this “dissolution/precipitation” behavior can in particular be sodium carbonate or potassium carbonate or sodium sulfate or calcium sulfate. This compound is in its dehydrated form at the start before mixing with liquid water. Thus, the moistened mass of starting material is preferably heated to a temperature (generally at least 36° C.) at which a hydrate of the compound having a “dissolution/precipitation” behavior is stable. If the starting material powder contains such a compound, in particular sodium carbonate, advantageously, the mixture of starting material powder and of liquid water is heated up to at least 36° C. during this operation of carrying out the mixing of liquid water and of starting material powder, so as to stabilize the hydrate of this compound, in particular sodium carbonate monohydrate. The moistened mass of starting material then contains this hydrate.

The cullet and the moistened mass of starting material are subsequently mixed in order to produce the SM/C mixture. The cullet thus comes into contact with the starting material powder after the latter has already been moistened with liquid water. The SM/C mixture is produced by a distinct system downstream of the tank used to produce the moistened mass of starting material powder. This system for producing a mixture of cullet with the moistened mass of starting material powder (SM/C mixture) can comprise a forwardly progressing belt on which the moistened mass of starting material powder and the cullet are deposited separately, that is to say one after the other on the belt. It is possible to add the cullet to the moistened mass of starting material powder. In order to carry out this operation, the moistened mass of starting material powder can, for example, forwardly progress on a belt and, at a fixed point above the belt, cullet is poured onto the starting material powder. Analogously, in order to produce the SM/C mixture, it is possible to add the moistened mass of starting material powder to the cullet. In this case, it is possible to cause the cullet to forwardly progress on a belt onto which the moistened mass of starting material powder is subsequently poured.

In the process according to the invention, a moistened mass of starting material powder is thus first produced by a means for producing this mixture comprising a tank provided with a stirring means, then this moistened mass exits from the tank via its outlet and is conveyed by a conveying means to a system (distinct from the means for carrying out the preceding mixing) for producing the SM/C mixture and then the SM/C mixture is conveyed to the preheater and introduced into the latter in order to be heated and dried therein and to be converted into a mass to be charged.

The SM/C mixture comprises starting material powder, cullet and liquid and/or complexed water. The starting material powder can comprise complexed (nonfree) water in a hydrate. The ratio of the mass of liquid water to the mass of complexed water in the SM/C mixture can vary between the start of the preparation of the moistened mass of starting material powder and the introduction of the SM/C mixture into the preheater due to the dissolution/precipitation phenomenon already touched on and which can lower the mass of liquid water in favor of the weight of complexed water.

After producing the SM/C mixture and in particular at the time of its introduction into the preheater, the SM/C mixture generally comprises at least 0.2%, in particular at least 0.4%, by total mass of water (sum of the complexed water and of the liquid, that is to say free, water) and at most 9%, in particular at most 3.4%, by total mass of water.

After producing the SM/C mixture and in particular at the time of its introduction into the preheater, the SM/C mixture generally comprises at least 0%, generally at least 0.1% and more generally at least 0.2% by mass of liquid water and at most 9%, generally at most 6%, by mass of liquid water. The objective is to have as little water as possible in the SM/C mixture for energy reasons but sufficient of it is necessary in order to structure the mass to be charged in order to accelerate the melting and to limit the fly-offs. These proportions of water thus represent a compromise.

The SM/C mixture generally comprises at least 1% and generally at least 5% and more generally at least 10% by mass of cullet. The SM/C mixture generally comprises at most 60% by mass of cullet.

The cullet may be moist during its mixing with the moistened mass of starting material but the proportion which has just been given is, of course, given on the basis of dry cullet. There is no particular advantage in the cullet being moist during the preparation of the SM/C mixture and it is even preferred for it to be dry. If appropriate, the cullet can be dried before mixing it with the moistened mass of starting material powder.

The SM/C mixture thus produced is subsequently poured into the preheater. For the case where the starting material powder contains a compound exhibiting a “dissolution/precipitation” behavior touched on above, such as sodium carbonate, advantageously, the cullet does not cause the temperature of the moistened mass of starting material powder within the SM/C mixture to fall below 36° C. If necessary, before being mixed with the cullet, the moistened mass of starting material powder is heated sufficiently above 36° C. for the mixing with the cullet not to cause its temperature to fall below 36° C. Thus, the moistened mass of starting material powder within the SM/C mixture, indeed even the whole SM/C mixture, enters the preheater generally having a temperature of between 36° C. and 90° C.

The device according to the invention is generally configured in order for the SM/C mixture to circulate continuously in the preheater and in order for the mass to be charged to be charged continuously to the furnace.

The mixing of starting material powder and of liquid water producing a moistened mass of starting material powder can be carried out in a tank provided with a stirring means, with an inlet for the starting material powder, with a feed of liquid water and/or of steam and with an outlet for the moistened mass of starting material powder. Such a tank can also be known as “kneader”.

The device according to the invention can be configured in order for the means for carrying out a mixing of starting material powder and of liquid water to operate noncontinuously (the term “batchwise” is also used). A mixing of starting material powder and of liquid water which produces the moistened mass of starting material powder is then carried out noncontinuously. In this case, the addition of liquid water can be carried out with an unvarying mass of starting material powder in the tank. As the preheater generally operates continuously, the SM/C mixture advances continuously in the preheater (generally in the vertical position). According to the free space at the inlet of the preheater, periodically and noncontinuously, SM/C mixture is produced and introduced into the preheater. Thus, according to the free space at the inlet of the preheater, a regulating system detects the need to introduce SM/C mixture into the preheater and controls the opening of the outlet of the tank and the preparation of SM/C mixture and the introduction of SM/C mixture into the preheater. The regulating system is capable of detecting free space in the preheater and, according to the free space detected, of controlling the preparation of a mixture of starting material powder, the preparation of SM/C mixture and the introduction of SM/C mixture into the preheater.

The starting material powder comprises the ingredients which have to participate in the melting of glass, such as silica, at least one flux for silica, such as sodium carbonate, optionally at least one refining agent, optionally at least one stabilizing agent, such as an alumina source (such as: feldspar, nepheline, phonolite, calcined alumina or aluminum hydroxide) or a calcium source, such as limestone, optionally at least one coloring agent and any compound desired for producing the final glass. Silica is generally the compound present in the greatest amount in the starting material powder.

Thus, apart from all liquid water, the powdered starting material can comprise:
from 30% to 99% by weight of SiO₂,
from 1% to 20% by weight of Na₂CO₃,
from 0% to 20% by weight of CaCO₃,
from 0% to 20% by weight of CaCO₃, MgCO₃,
from 0% to 5% by weight of alumina source,
from 0% to 1% by weight of Na₂SO₄,
from 0% to 1% by weight of CaSO₄.

Generally, the particle size of the powder of the starting material is such that its D50 is between 50 and 500 μm.

Advantageously, at least 90% of the mass of cullet consists of particles with a size of between 1 mm and 10 cm and generally of between 2 mm and 10 cm and more generally with a size of between 1 cm and 10 cm. A size of a cullet particle is the distance between its two most distant points.

The drying of the SM/C mixture, in particular by the combustion flue gases originating from the furnace, produces a reduction in the total water content of this mixture, that is to say the sum of the free water and of the complexed water, and a rise in its temperature. Preferably, the mass to be charged comprises less than 0.1% by total mass of water (sum of the mass of liquid water and of water in complexed form).

Advantageously, the SM/C mixture is heated to a temperature of between 100° C. and 500° C. and preferably between 200° C. and 500° C. and preferably between 250° C. and 400° C. in the preheater. The mass to be charged exiting from the preheater is thus in this temperature range. It is introduced into the furnace while also being in this temperature range. The transfer of the SM/C mixture from the preheater to the furnace can be carried out using a conveyor belt, endless screw, and the like. This transfer zone is preferably thermally insulated in order for the heat of the SM/C mixture to be retained between the preheater and the furnace.

All glass furnaces are concerned by the present invention and in particular cross-fired furnaces and end-fired furnaces.

### EXAMPLES

### Influence of the Water Content

Measurements of the cohesion of moistened starting material powder as a function of the water content show that the cohesion increases with the water content. Graded pellets of moistened mixtures of starting materials were prepared which contain the following mixture of powders (% given on a dry basis), none of these components of which was a hydrate:
60.3% by mass of sand
4.5% by mass of limestone
18.3% by mass of sodium carbonate
1.1% by mass of feldspar
14.9% by mass of dolomite
0.9% by mass of sodium sulfate,
   to which mixture liquid water was added in different proportions (2%, 4%, 6% of water of the sum of the mass of liquid water and of powder). These pellets were subsequently dried at 150° C. overnight in the air. Finally, they were crushed with a uniaxial compression measurement apparatus. The maximum force at the moment of breaking, that is to say immediately before crushing, was measured. The pellets with 6% by mass of water initially introduced are stronger than those with 4% of water, which are themselves stronger than those with 2% by mass of water. Observation of the aggregates with a scanning electron microscope shows that these increase in size with the water content of the moistened starting material powder. When the water content increases, the grains are connected together better by bridges, the aggregates formed are larger and more compact. Generally, aggregates with a size of greater than 2 cm are not observed. An aggregate size is the distance between its two most distant points.

### Influence of the Particle Size of the Cullet

A mixture of starting material powder and of liquid water is prepared in a jar in order to produce a moistened mass of starting material powder in a proportion of 3.6% of added water with respect to the moistened mass of starting material (mixture of sand, sodium carbonate, limestone, feldspar, sodium sulfate, coke). In order to do this, the mixture of dry powders is prepared beforehand and heated in a drying oven to 60° C., then the water is added and then the mixture is stirred in a 3D dynamic mixer for 5 minutes. This mixture finally has a temperature of at least 36° C. Stirring is halted, cullet is then added and the jar is stirred by hand for 1 minute. The amount of cullet was 40% by mass of that of the SM/C mixture. The contents of the jar are subsequently transferred into a cylinder-shaped mold in which they are gently pushed down manually so that their surface becomes flat. The mold is placed in a drying oven at 120° C. for 20 hours. The block formed is removed from the mold and then its uniaxial compressive strength is evaluated. The block and its compression test simulate the strength of an aggregate formed in the process according to the invention. The results giving the maximum forces achieved before failure of the block as a function of the particle size of the cullet are collated in the table below.

| | | |
|---|---|---|
| Example | Cullet size | Mean maximum force (N) |

| | | | |
|---|---|---|---|
| 1 | <1 | mm | 420 |
| 2 | 4-8 | mm | 100 |
| 3 | 8-16 | mm | 96 |

The “Cullet size” column gives the size range of the cullet particles per 100% of its mass. It is seen that the blocks of examples 2 and 3 fracture under a weaker force than for example 1, which is favorable to the unblocking of the materials flowing in the preheater since the large blocks possibly being formed in the latter will break up more easily.

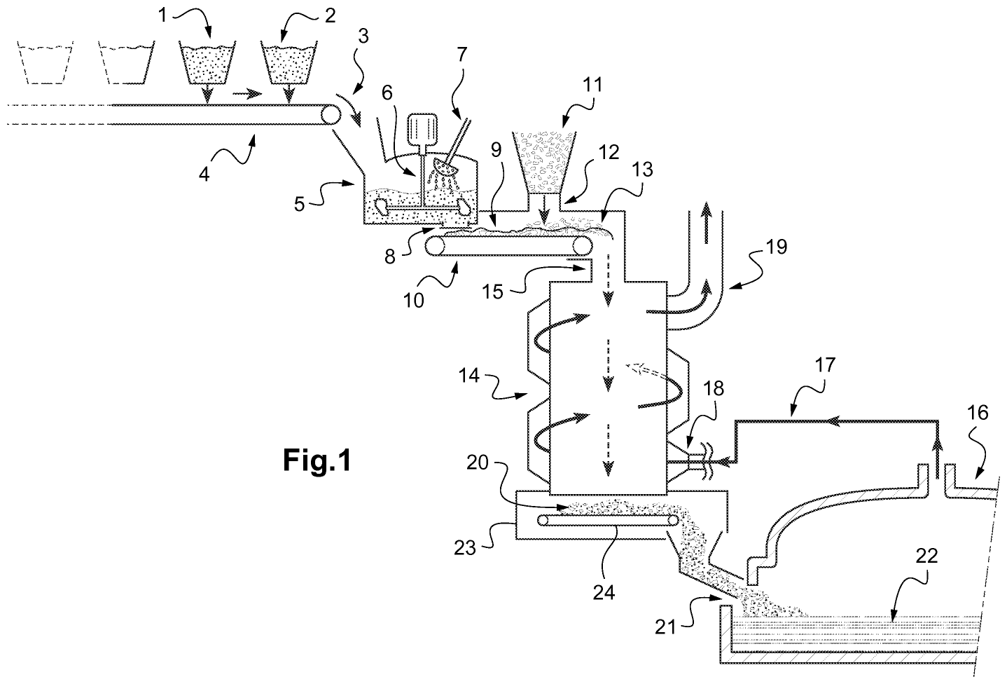

FIG. 1 diagrammatically represents a device according to the invention. The different compounds 1, 2, and the like, participating in the composition of the pulverulent starting material 3 (sand, sodium carbonate, and the like) are deposited in successive layers one after the other on a forwardly progressing belt 4. This powdered starting material is subsequently poured into the tank of a kneader 5 provided with a paddle stirrer 6 and into which liquid water and steam (condensing to give liquid water in the tank) are introduced. In this kneader, the moistened mass of starting material powder is generally heated to at least 36° C. The kneading operation is carried out noncontinuously (“batchwise”), that is to say with a given amount of material, the outlet door 8 being closed and opening periodically to deliver moistened mass of starting material powder 9 to a forwardly progressing belt 10. Cullet 11 is subsequently deposited at a fixed point 12 on this moistened mass in forward progression in order to constitute the SM/C mixture 13. This SM/C mixture feeds the inlet 15 of a preheater of starting materials 14. In this preheater, the SM/C mixture descends vertically into parallelepipedal steel compartments. Hot combustion gases 17, the temperature of which is approximately 800° C., originating from the glass furnace 16 are conveyed by a pipe and introduced at 18 into a bottom part of the preheater. These gases circulate by winding in the preheater around the parallelepipedal compartments in order to heat the SM/C mixture which they contain. Overall, these gases circulate countercurrentwise to the SM/C mixture. These gases subsequently exit at 19 in a top part of the preheater. The heating of the SM/C mixture produces steam. This is free water of the SM/C mixture and, if appropriate, water originating from the dehydration of a hydrate, such as sodium carbonate hydrate, present in the SM/C mixture. This steam can be removed during the descent of the SM/C mixture by virtue of orifices in the parallelepipedal compartments, in which case this steam mixes with the combustion gases circulating around the parallelepipedal compartments. The dry and hot SM/C mixture exits at the bottom of the preheater and then constitutes the mass to be charged 20. The latter is subsequently charged at 21 to the furnace 16 containing a glass bath 22. A forwardly progressing belt 24 conveys this mass to be charged 20 to a recess 21 for introduction of vitrifiable starting materials. The descent of the SM/C mixture is continuous in the preheater 14 and the feeding of the furnace with mass to be charged is also continuous. The feeding at 15 of the preheater with SM/C mixture can be periodical (semicontinuous) according to the descent of the material in the preheater. According to the free space in the preheater, a regulating system triggers the opening of the outlet 8 of the tank 5, the preparation of SM/C mixture on the belt 10 and the introduction of SM/C mixture into the preheater. Protection 23 surrounds the SM/C mixture between the preheater and the furnace in order to limit its loss of heat.

1. A device for the preparation and charging of starting materials for a glass furnace, comprising:
a means for carrying out a mixing of starting material powder and of liquid water, producing a moistened mass of starting material powder, said means comprising a tank provided with a stirring means, with an inlet for the starting material powder, with a feed of liquid water and/or of steam and with an outlet for the moistened mass of starting material powder,
a system for carrying out a mixing of cullet with the moistened mass of starting material powder which has exited from the tank, in order to produce a mixture of starting material and of cullet, known as SM/C mixture,
a starting material preheater in which the SM/C mixture circulates and is heated and dried in order to produce a mass to be charged, and
a system for charging the glass furnace with the mass to be charged.

2. The device as claimed in claim 1, wherein the system for producing the SM/C mixture comprises a forwardly progressing belt on which the moistened mass of starting material powder and the cullet are deposited separately.

3. The device as claimed in claim 1, wherein the SM/C mixture flows at least partially vertically in the preheater.

4. The device as claimed in claim 1, further comprising a pipe adapted to convey combustion flue gases generated by the glass furnace to the preheater, so as to provide the latter with the thermal energy for heating and drying the SM/C mixture.

5. The device as claimed in claim 1, wherein the combustion flue gases and the SM/C mixture circulate in separate pipes in the preheater.

6. The device as claimed in claim 1, wherein the device is configured in order for the SM/C mixture to circulate continuously in the preheater and in order for the mass to be charged to be charged continuously to the furnace.

7. The device as claimed in claim 1, wherein the device is configured in order for the means for carrying out the mixing of starting material powder to operate noncontinuously.

8. The device as claimed in claim 7, wherein a regulating system is capable of detecting free space in the preheater and, according to the free space detected, of controlling the preparation of a mixture of starting material powder, the preparation of SM/C mixture and the introduction of SM/C mixture into the preheater.

9. A glass furnace equipped with the device of claim 1.

10. A process for the melting of glass in a furnace, comprising:
carrying out, in a tank, a mixing of starting material powder and of liquid water, producing a moistened mass of starting material powder, said tank being provided with a stirring means, with an inlet for the starting material powder, with a feed of liquid water and/or of steam and with an outlet for the moistened mass of starting material powder, then
mixing cullet with the moistened mass of starting material powder which has exited from the tank, in order to produce a mixture of starting material and of cullet, known as SM/C mixture, then
heating and drying said SM/C mixture in a preheater, producing a mass to be charged, then
charging to the furnace said mass to be charged.

11. The process as claimed in claim 10, wherein, in order to produce a mixture of starting material powder and of liquid water, liquid water is added to the starting material powder so that a sum of the mass of the liquid water contributed by the starting material powder and of the liquid water added to the starting material powder represents from 0.5% to 10% of the moistened mass of starting material powder.

12. The process as claimed in claim 10, wherein the SM/C mixture comprises from 0.2% to 9% by total mass of water, sum of the complexed water and of the liquid water.

13. The process as claimed in claim 10, wherein, at the inlet of the preheater, the SM/C mixture comprises from 0% to 9% by mass of liquid water.

14. The process as claimed in claim 10, wherein the mixing of starting material powder and of liquid water producing a moistened mass of starting material powder is carried out in a tank equipped with a stirring means, the moistened mass of starting material powder being brought therein to at least 36° C.

15. The process as claimed in claim 10, wherein the SM/C mixture enters the preheater while having a temperature of between 36° C. and 90° C.

16. The process as claimed in claim 10, wherein cullet is mixed with the moistened mass of starting material powder in order to produce the SM/C mixture containing from 1% to 60% by mass of cullet.

17. The process as claimed in claim 10, wherein the starting material powder comprises silica and a flux for silica.

18. The process as claimed in claim 10, wherein the starting material powder comprises a compound capable of dissolving at least partially in the liquid water of the moistened mass of starting material powder and of then precipitating in the hydrate form.

19. The process as claimed in claim 10, wherein a particle size of the starting material powder has a D50 of between 50 and 500 μm.

20. The process as claimed in claim 10, wherein at least 90% of the mass of cullet consists of particles with a size of between 1 mm and 10 cm.

21. The process as claimed in claim 10, wherein the SM/C mixture is heated to a temperature of between 100° C. and 500° C. in the preheater.

22. The process as claimed in claim 10, wherein the mass to be charged comprises less than 0.1% by total mass of water, sum of the mass of liquid water and of water in complexed form.

23. The process as claimed in claim 10, wherein the SM/C mixture circulates continuously in the preheater and wherein the mass to be charged is charged continuously to the furnace.

24. The process as claimed in claim 10, wherein a mixing of starting material powder and of liquid water which produces the moistened mass of starting material powder is carried out noncontinuously.
